(19) United States
(12) Patent Application Publication
(10) Pub. No.: US 2003/0212848 A1
(43) Pub. Date: Nov. 13, 2003

(54) Double interface CF card

(76) Inventors: Wen-Tsung Liu, Taipei Hsien (TW); Chia-Li Chen, Taipei (TW)

Correspondence Address: Hsu & Associates, P. O. Box 72, Nankang, Taipei, TW

(21) Appl. No.: 10/216,608

(22) Filed: Aug. 12, 2002

(30) Foreign Application Priority Data
May 9, 2002 (TW) 091109710

(51) Int. Cl. G06F 13/14

(52) U.S. Cl. 710/305

(57) ABSTRACT

A double interface CF card includes a CF interface, a USB interface, a control chip and multiple erasable memories. In particular, the circuit and electric design in the flash memory card contain a CF bus interface circuit and a USB bus interface circuit, both of which are built in the control chip to communicate with the CF interface or the USB interface; a power transfer and protection circuit for converting the power voltage into an internal voltage suitable for the compact flash memory card and switching off the other interface; an interface detection and selection circuit for detecting a system end of the CF interface or the USB interface and switching the CF interface circuit or the USB interface circuit as the correct working mode; and a micro controller built in the control chip for accepting instruction codes transferred from the system end and treating the instruction codes with necessary response based on the system specification after switching.

### BACKGROUND OF THE INVENTION

1. Field of the Invention

This invention is related with a double interface CF card, in particular, to a double interface compact flash memory card.

2. Description of Related Art

Compact Flash (CF) Card, which is invented by SanDisk (USA) in 1994, is a new standard for memory cards. It comprises of multi flash memory chips and a control chip.

CF flash memory card is very light, thin, and small (50 pins, 43 mm (L)×36 mm (W), thickness: Type I : 3.3 mm, Type II: 5 mm). Besides smallness and lightness, this product is featured with long-term preservation for information, high reliability, and low power consumption and etc. so that it is a favorite electronic product to consumers. It has been widely used in the following fields:

(1) System Application (including PC, industrial PC, and server);

(2) Computer Peripheral Equipments including duplicating machine, printer, scanner, projector, and external flash memory card and etc.;

(3) Information Appliance (IA) including HDTV, STB, Media Player and etc.;

(4) Portable Digital Products including PDA, Digital Camera, MP3 Players and etc.

This memory card based on Semiconductor Storage technology has gradually taken the position of traditional Magnetic Storage technologies (diskette) and Optical storage technologies (CD). Because CF flash memory cards have advantages in size, power consumption, information preservation, data transfer rate, rewrite feature, shock proof, and moisture-proof, etc., they have been extensively adopted in portable devices and information appliances as a modern portable media.

On the other hand, The USB (Universal Serial Bus) interface introduced in 1996, which is a extended interface for PCs or portable devices, is featured with high data transfer rate, hot-swapping, plug & play, and easy installation, etc. Therefore, the legacy interface for PCs and peripheral equipment is substituted by highly efficient transfer interfaces such as USB. The system end can communicates with various peripheral equipments via USB interfaces, eliminating the need for driver installation. As the result, products embedding a USB interface are widely used not only in computers (desktop or notebook) and peripheral equipment (e.g., scanner, keyboard, printer, mouse, etc.) but also in information appliances (e.g., PDA, DSC, MP3 player, Removable Hard Disk, etc.).

There are more and more products utilizing CF flash memory card as the storage media as well as products utilizing USB as the extended interface, all of which are similar in interconnection. However, a media driver is necessary to connect with above digital products with USB interface currently. Furthermore, CF flash memory cards can only work with CF interface, i.e., not suitable for portable products, PCs, or peripheral equipment with USB interface. This driver device not only adds cost to customers, but also brings inconvenience to them.

By now, no technology or product combining CF interface and USB interface is available in the market, that is to say, consumers have to lend themselves to the game rules (i.e., technologies and products developed), price, and product specification set down by manufacturers and vendors.

### SUMMARY OF THE INVENTION

To solve above problems, the inventor invented a technology and product that combines CF card and USB card into one. After hard study and tests, the inventor put forth a “Double Interface CF Flash Memory Card” product, which may has extensive and powerful market potential.

An object of this invention is to provide a double interface CF card with a micro controller to perform detection, switch on/off, and control of the program at the system end of CF interface and USB interface and internal circuits (including the voltage transformation and protection circuit, the interface detection and selection circuit, and CF bus interface, and USB bus interface) to fulfill support and arbitration tasks. This product integrates CF interface and USB interface to facilitate consumers to apply it in various computers and information appliances conveniently to implement storage, transfer, and exchange of digital information directly.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a block diagram of a control circuit in a CF card according to the present invention;

FIG. 2 is a block diagram of an arbitration circuit (performing detection, control and switching functions) of the CF card of the present invention; and

FIG. 3 is a preferred flow chart of detection and selection circuit used by the CF card of the present invention.

### DETAILED DESCRIPTION OF THE PREFERRED EMBODIMENT

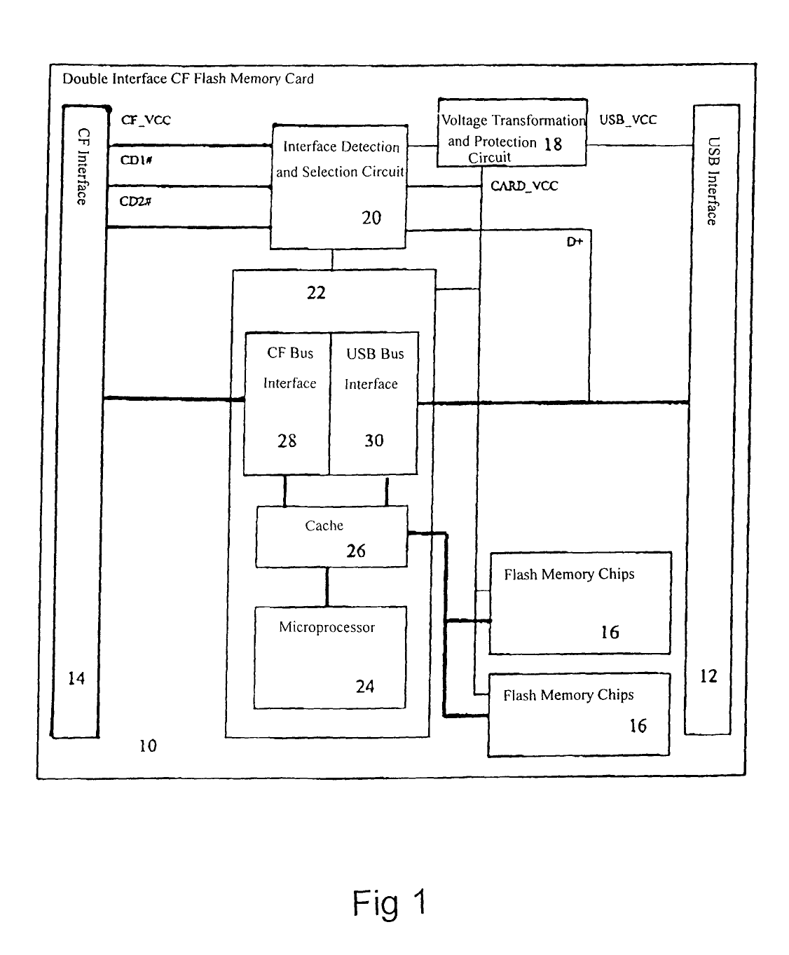

Referring to FIG. 1, a block diagram of a control circuit of the double interface CF card is illustrated. The CF card (10) has a USB interface (12), a CF interface (14), a control chip (22), and several flash memories, (16). Further the CF card is provided with the following circuits:

a CF bus interface circuit (28) built in a control chip 22 to communicate with the CF interface (14) when the CF interface (12) is selected;

a USB bus interface circuit (30) built in the control chip 22 to communicate with the USB interface (12) when the USB interface (12) is selected;

a power source transfer and protection circuit (18) to convert the voltage at the CF interface or the USB interface currently used to the internal voltage of the CF card and switch off the other interface circuit; the voltage transformation and protection circuit (18) also provides isolation and protection to the unused system interface and voltage regulation functions when switching;

a interface detection and selection circuit (20) coupling with the power source transfer and protection circuit (18) to start the CF card (10) and switch the circuit to the CF bus interface circuit (28) or the USB bus interface circuit (30) when a CF interface (14) or USB interface (12) is detected; and

a micro controller (24) built in the control chip (22) to accept instruction codes transmitted from the system end and perform necessary treatment and response.

It is noted that the CF card (10) supports the system end connected to it with the CF interface (14) or the USB interface (12) at different time. With the micro controller (24), the CF card (10) can control the CF/USB interface to exchange data with multiple flash memories through the following steps:

power on;

converting the power voltage to the internal voltage of the CF card (10) and isolate the other interface circuit currently not used;

Switches to and start the corresponding circuit (CF bus interface circuit (28) or USB bus interface circuit (30)) in accordance with the interface (CF interface (14) or USB interface (12)) detected by the interface detection and selection circuit (20); and

In accordance with the specification of the interface currently used (switched to and started by the interface detection and selection circuit (20)), the micro controller will accept the instructions transferred from the system end connected and perform necessary process and response.

The control chip (22) of the CF card (10) includes a cache unit (26) coupling with the flash memory chips (16) to exchange data with the CF or USB interface 14, 12 currently used. The control chip also includes a micro controller (24) built with a program code memory, a cache, and an access interface (not shown in the figures). With those elements, the micro controller performs functions such as detection, switching and program control. In other words, the micro controller (24) is the control kernel of this invention. The program code memory, the cache, the access interface are conventional elements and no detail will be described further.

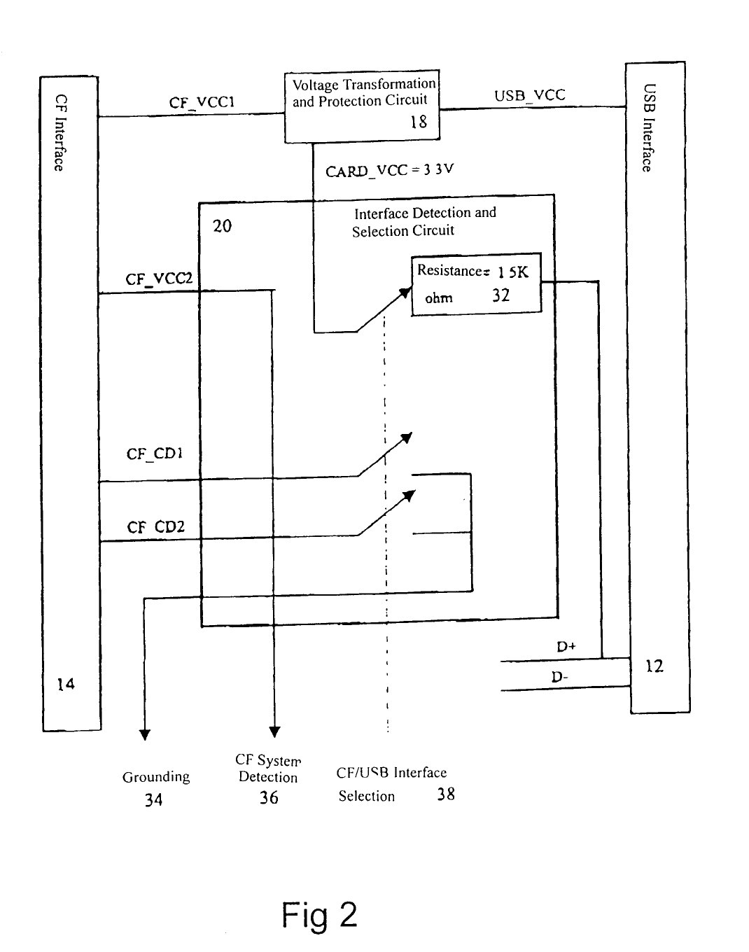

Referring to FIG. 2, a block diagram of the arbitration circuit implemented according to the invention to carry out detection, control, and switching functions. From this figure, we can further understand how the CF card of the invention arbitrates and processes in accordance with different electric signals of the two interfaces. As shown in the figure, when a CF interface (14) is connected, i.e., the double interface CF memory card connects to the system end with a CF interface (14), which has 50 pins (power pins and signal pins), the CF card (10) will confirm it with the CF_VCC2 signal. To detect the CF interface (14), the CF card (10) grounds CF_CD1 and CF_CD2 (34) with the control of interface detection and selection circuit (20) by the micro controller (24) to select the CF interface (14) and switch off the other interface (USB interface (12)).

Similarly, when the CF card (10) is connected to the system end with a USB interface (12), which includes four sets of power wires and signal wires, the D+signal wire is used for the CF card to confirm the USB interface (12). According to the specification for USB interface (12), the D+signal wire has to be connected to a power signal of 3.0˜3.6V via a resistance (32) as soon as the system end with USB interface being connected. The CF card (10) connects with the D+signal wire of the USB interface (12) to the power via the resistance (32) with the interface detection and selection circuit (20) controlled by the micro controller (24) to select the USB interface (12) and switch off the other interface (CF interface (14)).

In accordance with the specification for CF flash memory cards, apparently, 2 sets of VCC power pins should be provided in the 50 pins. One of them (CF_VCC1) is connected to the power transformation and protection circuit (18) of the Double Interface CF Flash Memory Card (10), and the other (CF_VCC2) serves as the system end that is used to detect whether a CF interface (14) is connected (i.e., CF system detection (36)) based on the grounding (34) of CF_CD1 and CF_Cd2. The interface detection and selection circuit (20) uses 3 sets of switching signals: CF_CD1, CF_CD2, and USB D+, in which, CF_CD1 and CF_CD2 switch between grounding and open circuit, and switches between connection to the power (3.3V) via the resistance (32) (1.5K ohm) and open circuits. When the CF card (10) detects and determines the interface connected through detecting the CF_CC2 signal, it performs necessary switching to above three sets of signals with the interface detection and selection circuit (20).

According to the specification for CF flash memory cards, the power should be applied only when the flash memory card detects the system end connected via the CF interface (14) on the basis of grounding of CF_CD1 and CF_CD2 (34). However, when the CF card (10) in this invention is connected to a USB interface (12), the voltage transformation and protection circuit (18) will convert the USB_VCC power to the internal voltage used by this card, and connects the D+signal wire to the power (3.0˜3.6V) via the resistance (32) with the interface detection and selection circuit (20) controlled by the micro controller (24) to initialize the USB interface (12) functionality of the CF card (10). The internal power circuit will be activated only when either an USB interface (12) or CF interface (14) described above is correctly detected and selected.

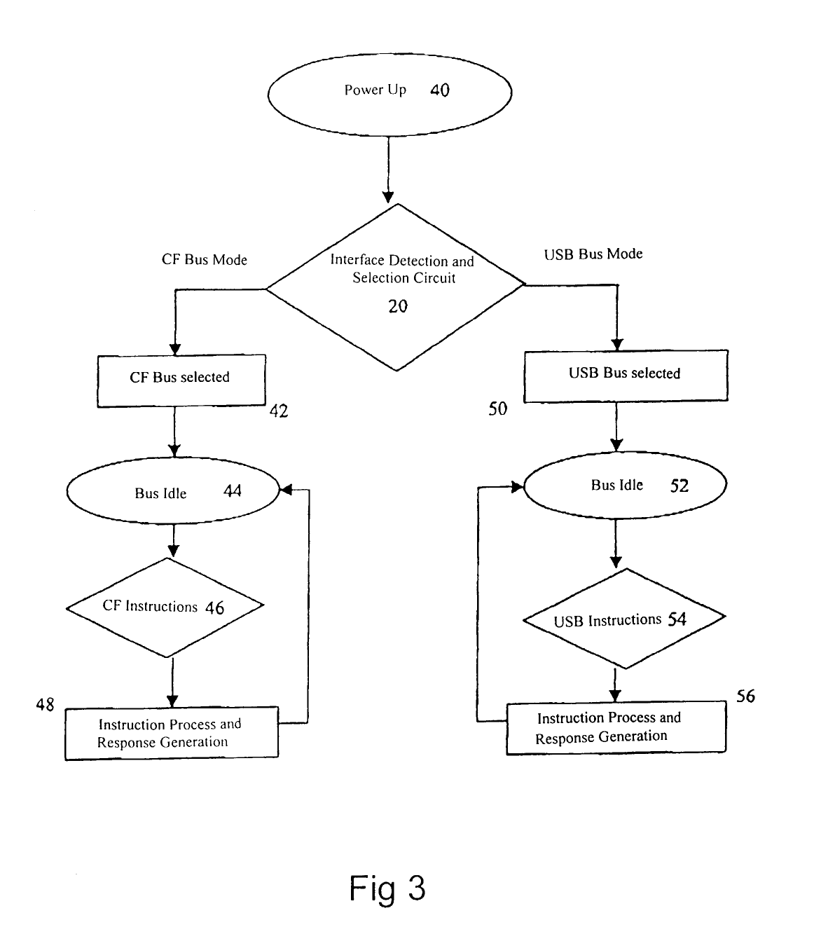

As shown in FIG. 3, a preferred flow chart of the detection and selection circuit used by the CF card (10) implemented in accordance with this invention. This circuit support both CF interface and USB interface. Accordingly, a service program dealing with the two interfaces and corresponding transfer protocols should host in the micro controller (24) of the CF card (10) this figure illustrates that when the system starts the power unit (40) of the CF card (10), the micro controller (24) of the CF card (10) will switch the CF card (10) to the correct working mode and initialize the corresponding system interface process according to the type of interface detected by the interface detection and selection circuit (20). When the system interface is initialized, the micro controller (24) will receive the instructions and perform necessary process and response according to the specification for the interface currently used. In other words, if the system interface detected by the interface detection and selection circuit (20) is a CF bus (50 pins), it will select the CF bus (42) and initialize the standard CF operation cycle, i.e., generates a CF instruction (46) related with “Bus Idle” (44), processes instructions, generates necessary response (48), and finally returns to “Bus Idle” (44) state. If the system interface detected by the interface detection and selection circuit (20) is a USB bus, it will select the USB bus (50) and initialize the standard USB operation cycle, i.e., generates a USB instruction (54) related with “Bus Idle” (52), processes instructions, generates necessary response (56), and finally returns to “Bus Idle” (52) state.

It should be emphasized that the Double Interface CF Flash Memory Card (10) is designed based on the embedded CF and USB interfaces. The control chip and the configuration of elements in the circuit are detailed in a preferred embodiment showed above. However, the Double Interface CF Flash Memory Card (10) can be a CF Type I, a CF Type II, an Extended CF card or any CF card.

In conclusion, the double interface CF flash Memory card described in above preferred embodiment is featured with the following advantages:

A micro controller is employed to perform all detection, switching, and control the system end with CF interface/USB interface, and a power transfer and protection circuit, a interface detection and selection circuit, and the corresponding CF bus interface circuit or USB bus interface circuit is used for performing support and arbitration tasks to integrate a CF interface and a USB interface in a single CF card. In this way, the micro controller of the double interface CF card of this invention combines functions of a conventional CF interface and a USB interface to give consumers the maximum convenience while a computer and any IA products is in use for functions of digital data storage, transmission and exchange.

While the invention has been described with referencing to a preferred embodiment thereof, it is to be understood that modifications or variations may be easily made without departing from the spirit of this invention, which is defined by the appended claims.

1. A double interface CF (compact flash) card, comprising
a CF interface;
a USB interface;
a control chip; and
a plurality of erasable memories; and further comprising:
a CF bus interface circuit, being built in the control chip to communicate with the CF interface;
a USB bus interface circuit, being built in the control chip to communicate with the USB interface;
a power transfer and protection circuit, converting a power source into an internal voltage suitable for the CF and switching off another interface;
an interface detection and selection circuit, being coupled with the power transfer and protection circuit to detecting a system end of the CF interface or the USB interface and switching the CF interface circuit or the USB interface circuit as the correct working mode; and
a micro controller, being built in the control chip to accept instruction codes transmitted from the system end and treat the instruction codes with necessary response based on the system specification thereof after switching.

2. The double interface CF card as defined in claim 1, wherein the control chip further comprises a cache unit coupling with the erasable memories to transmit or exchange data with the CF interface or the USB interface whichever is assigned.

3. The double interface CF card as defined in claim 1, wherein the micro controller further comprises a built in program code memory, a built in cache memory and an access interface to execute all functions related with interface detection, switching, and program control.

4. The double interface CF card as defined in claim 1 can be a CF Type I, a CF Type II, an extended CF card and any CF flash memory card.

5. A method for operating a double interface CF card, which supports a CF interface and a USB interface connected to a system end at different times with a single micro controller controlling a plurality of erasable memories therein and transmitting and exchanging data with any of the CF and the USB interfaces, comprising the following procedures:
starting a power source;
converting the power source to an internal voltage suitable for the CF card and cutting off and isolating another interface circuit;
switching to and starting a CF bus interface circuit or a USB bus interface circuit based on a system detected with an interface detection and selection circuit; and
according to an interface specification of the detected system, the micro controller accepting instruction codes transmitted from the system end and treating the instruction codes with a response.

6. The double interface CF card as defined in claim 8, wherein the micro controller further comprises a built in program code memory, a built in cache memory and an access interface to execute all functions related with interface detection, switching, and program control.

7. The double interface CF card as defined in claim 5 can be a CF Type I, a CF Type II, an extended CF card and any CF flash memory card.

8. A double interface flash memory card, comprising:
a plurality of erasable memories;
a CF interface, complying with a CF interface specification;
a USB interface, complying with a USB interface specification;
a power source transfer and protection circuit, converting a power source into an internal voltage suitable for the CF and switching off another interface;
an interface detection and selection circuit, being coupled with the power transfer and protection circuit to detecting a system end of the CF interface or the USB interface and switching the CF interface circuit or the USB interface circuit as the correct working mode; and
a control chip, being built with a micro controller, a CF bus interface circuit and a USB bus interface circuit;
wherein, the micro controller accepts instruction codes transmitted from a system end and treats the instruction codes with necessary response based on a system specification after switching.

9. The double interface flash memory card as defined in claim 8, wherein the control chip further comprises a cache unit coupling with the erasable memories to transmit or exchange data with the CF interface or the USB interface whichever is assigned.

10. The double interface flash memory card as defined in claim 8, wherein the micro controller further comprises a built in program code memory, a built in cache memory and an access interface to execute all functions related with interface detection, switching, and program control.
